(19) United States
(12) Patent Application Publication
(10) Pub. No.: US 2010/0165680 A1
(43) Pub. Date: Jul. 1, 2010

(54) POWER CONVERSION APPARATUS

(75) Inventor: Fumitaka YOSHINAGA, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/530,425

(22) PCT Filed: Mar. 3, 2008
(86) PCT No.: PCT/JP2008/054227

§ 371 Date: Oct. 14, 2009

(30) Foreign Application Priority Data
Mar. 9, 2007 (JP) 2007-060573

(51) Int. Cl. H02M 7/00

(52) U.S. Cl. 363/123; 363/141

(57) ABSTRACT

An inverter module has a first inverter driving a first electric load and a second inverter driving a second electric load, mounted on a common insulation substrate. In the first inverter, the arms of the U, V and W phases are arranged on the insulation substrate such that arms adjacent in the horizontal direction in the drawing are located displaced from each other in the vertical direction in the drawing. In the second inverter, the arms of the U, V and W phases are arranged on the insulation substrate such that arms adjacent in the horizontal direction in the drawing are displaced from each other in the vertical direction in the drawing. Moreover, the arm of the first inverter and the arm of the second inverter are arranged to be adjacent along the horizontal direction in the drawing. By such an arrangement, the in-plane temperature distribution can be rendered uniform without having to increase the area occupied by the insulation substrate.

### TECHNICAL FIELD

The present invention relates to power conversion apparatuses, and more particularly, a power conversion apparatus including a plurality of power converters.

### BACKGROUND ART

Recently, attention is focused on hybrid vehicles and electric vehicles as vehicles taking into account environmental issues. A hybrid vehicle includes, in addition to a conventional engine, a motor as the motive power supply, driven by a DC power supply via an inverter. In addition to achieving the power supply by driving the engine, the DC voltage from the DC power supply is converted into AC voltage by the inverter, and the converted AC voltage is used to rotate the motor to achieve motive power. An electric vehicle includes, as the motive power supply, a motor driven by a DC power supply via an inverter.

An intelligent power module (IPM) incorporated in such hybrid vehicles or electric vehicles converts the DC power supplied from a DC power supply into AC power to drive the motor, by switching speedily a semiconductor switching element (power semiconductor element) such as an IGBT (Insulated Gate Bipolar Transistor).

For example, Japanese Patent Laying-Open No. 2003-309995 discloses a motor-driving inverter supplying electrical power to each phase of a multiphase AC motor. An inverter module is configured having an element formation region connected to an upper arm that is connected to the high potential side of the power supply, and an element formation region connected to a lower arm that is connected to the low potential side of the power supply, connected in parallel for each phase of the multiphase AC motor. A plurality of elements are formed in each element formation region. The inverter module is characterized in that the relationship among a first element distance, a second element distance, and a third element distance is selected so that the first element distance is set larger than the third element distance, and the first element distance is set larger than the second element distance. The first element distance refers to the distance across elements within each element formation region. The second element distance refers to the distance across elements between element formation regions connected to different arms of the same phase. The third element distance refers to the distance across elements between adjacent element formation regions connected to the same phase of a different phase.

According to Japanese Patent Laying-Open No. 2003-309995, the arrangement position of each element formation region is optimized such that the first element distance that is the distance across elements arranged in the same arm of the same phase, energized simultaneously to generate heat, is larger than the second element distance and the third element distance. Accordingly, increase in the temperature rise by heat interference between element formation regions can be reduced as much as possible, allowing downsizing.

Some driving systems for hybrid vehicles and electric vehicles have a plurality of motors incorporated, each motor driven independent of each other by an inverter. For example, Japanese Patent Laying-Open No. 2006-158173 discloses a driving system for a hybrid vehicle, configured to distribute power among an engine, a generator, and a motor. According to the configuration, the generator and motor each are driven by switching-control of semiconductor elements constituting a corresponding inverter.

An IPM employed in such a driving system includes an inverter controlling the generator and an inverter controlling the motor, both formed integrally on a common element substrate in view of the demand for downsizing imposed due to space constraints in mounting. In the case where the generator and motor are driven under such a configuration, the element substrate will attain high temperature by receiving heat generated from the semiconductor elements of the corresponding inverter. Therefore, a cooling mechanism is provided below the element substrate for cooling.

Since the drive currents supplied to the generator and motor take variable values that change independently according to the requested output, there is a relative relationship in magnitude between the amount of heat generated from the inverter controlling the generator and the amount of heat generated from the inverter controlling the motor. Deviation is seen in the in-plane temperature distribution at the element substrate, namely the region where an inverter having a relatively great amount of heat generation is mounted will become higher in temperature than other regions. As a result, the cooling capability of the cooling mechanism will become insufficient at the region of high temperature. There was a problem that it is difficult to suppress temperature increase of semiconductor elements located in the relevant region.

As an approach to suppress temperature increase at some of the semiconductor elements, there is known a method of controlling the cooling mechanism to have the cooling capability fixed to the level required corresponding to the highest heat generation. However, this method will needlessly increase power consumption of the cooling mechanism, causing degradation in the fuel cost for vehicles incorporating an IPM.

Moreover, in the case where a large-scale cooling mechanism having a higher cooling capability is provided, the size and cost of the IPM will be increased, which will conflict with the demand for downsizing imposed on an IPM due to space constraints during mounting.

The aforementioned Japanese Patent Laying-Open No. 2003-309995 only teaches means for suppressing temperature increase of semiconductor elements in an inverter module with a single inverter, and is silent about means for overcoming deviation in the temperature distribution at the element substrate encountered when a plurality of inverters are incorporated.

In view of the foregoing, an object of the present invention is to suppress, in a power conversion apparatus including a plurality of power converters, temperature increase of semiconductor elements constituting each power converter.

### DISCLOSURE OF THE INVENTION

According to an aspect of the present invention, a power conversion apparatus includes a first power converter driving a first electric load by switching-control of a plurality of first semiconductor elements, and a second power converter driving a second electric load by switching-control of a plurality of second semiconductor elements. The plurality of first semiconductor elements are organized into a plurality of first semiconductor element groups, each configured including at least one first semiconductor element. The plurality of second semiconductor elements are organized into a plurality of second semiconductor element groups, each configured including at least one second semiconductor element. The plurality of first semiconductor element groups are arranged in alignment in a first direction on a substrate, and at least some of the first semiconductor element groups adjacent in the first direction are arranged displaced from each other in a second direction perpendicular to the first direction. The plurality of second semiconductor element groups are arranged in alignment in the first direction on the substrate, and at least some of the second semiconductor element groups adjacent in the first direction are arranged displaced from each other in the second direction, and to be adjacent to the first semiconductor element group along the first direction.

According to the power conversion apparatus set forth above, both downsizing and uniformity in the in-plane temperature distribution can be achieved at a substrate where first and second semiconductor elements each generating heat according to the current flow supplied to a corresponding electric load are arranged. Accordingly, increase in the temperature of the semiconductor element can be suppressed without having to increase the cooling capability of the cooling mechanism. Thus, downsizing of the power conversion apparatus can be realized.

Preferably, the first power converter is a first inverter carrying out power conversion between a power supply and the first electric load. Each of the plurality of first semiconductor element groups constitutes a phase of the first inverter. The second power converter is a second inverter carrying out power conversion between the power supply and the second electric load. Each of the plurality of second semiconductor element groups constitutes a phase in the second inverter.

According to the power conversion apparatus set forth above, in-plane temperature distribution can be rendered uniform without having to increase the area occupied by the substrate by arranging each of the first and second inverters such that the phases adjacent in the direction of alignment are located in a displaced manner, and phases of different inverters are adjacent along the direction of alignment.

Preferably, the first power converter is a first inverter carrying out power conversion between the power supply and the first electric load. Each of the plurality of first semiconductor element groups constitutes an arm of each phase in the first inverter. The second power generator is a second inverter carrying out power conversion between the power supply and the second electric load. Each of the plurality of second semiconductor element groups constitutes an arm of each phase in the second inverter.

According to the power conversion apparatus set forth above, in-plane temperature distribution can be rendered uniform without having to increase the area occupied by the substrate by arranging each of the first and second inverters such that arms of identical phase adjacent in the direction of alignment are located in a displaced manner, and arms of different inverters are adjacent along the direction of alignment.

Preferably, the power conversion apparatus further includes a third power converter carrying out voltage conversion between the power supply and the first and second power converters by switching-control of a plurality of third semiconductor elements. The plurality of third semiconductor elements are organized into a plurality of third semiconductor element groups, each configured including at least one third semiconductor element. Each of the plurality of third semiconductor element groups is arranged in alignment in the first direction on the substrate, and at least some of the third semiconductor element groups adjacent in the first direction are arranged displaced from each other in the second direction, and to be adjacent to the first or second semiconductor element group along the first direction.

According to the power conversion apparatus set forth above, downsizing and uniformity in in-plane temperature distribution can both be achieved even in the case where a third semiconductor element constituting a converter is additionally arranged in alignment on the same substrate.

According to another aspect of the present invention, a power conversion apparatus converts power received between a first power supply line and a second power supply line from a power supply. The power conversion apparatus includes a plurality of first semiconductor elements connected in parallel between the first power supply line and an output conductor, and a plurality of second semiconductor elements connected in parallel between the second power supply line and the output conductor. The plurality of first semiconductor elements are arranged in alignment in a first direction on a substrate, and at least some of the first semiconductor elements adjacent in the first direction are arranged displaced from each other in a second direction perpendicular to the first direction. The plurality of second semiconductor elements are arranged in alignment in the first direction, and at least some of the second semiconductor elements adjacent in the first direction are arranged displaced from each other in the second direction, and to be adjacent to the first semiconductor element along the first direction.

According to the power conversion apparatus set forth above, both downsizing and uniformity in the in-plane temperature distribution can be achieved at a substrate where a plurality of semiconductor elements energized simultaneously to generate heat are mounted. Accordingly, increase in temperature of semiconductor elements can be suppressed without having to increase the cooling capability of the cooling mechanism. Thus, downsizing of the power conversion apparatus can be realized.

Preferably, the power conversion apparatus is an inverter carrying out power conversion between DC power received between the first power supply line and second power supply line and AC power transmitted to and received from an electric load.

According to the power conversion apparatus set forth above, in-plane temperature distribution of the substrate can be rendered uniform by alleviating heat interference between a plurality of semiconductor elements constituting the same arm of the same phase in an inverter.

Preferably, the power conversion apparatus is a converter carrying out voltage conversion of DC power received between the first and second power supply lines.

According to the power conversion apparatus set forth above, in-plane temperature distribution of the substrate can be rendered uniform by alleviating heat interference between a plurality of semiconductor elements constituting the same arm in a converter.

Preferably, the power conversion apparatus further includes a cooling mechanism provided to allow heat transfer with a substrate.

Since the cooling capability of a cooling mechanism does not have to be increased in the power conversion apparatus set forth above, the power of the cooling mechanism can be saved. As a result, the fuel cost of the vehicle incorporating the power conversion apparatus can be improved. Moreover, downsizing of the power conversion apparatus can be realized since increase in the size of the cooling mechanism can be suppressed.

In a power conversion apparatus including a plurality of power converters of the present invention, temperature increase of semiconductor elements constituting each power converter can be suppressed. As a result, the area occupied by the element substrate can be reduced while ensuring the cooling performance for the semiconductor elements. Thus, downsizing of the power conversion apparatus can be realized.

### BRIEF DESCRIPTION OF THE DRAWINGS

FIG. 1 is a schematic block diagram representing an entire configuration of a hybrid vehicle provided as an example of incorporating a power conversion apparatus of the present invention.

FIG. 2 is an electric circuit diagram representing the main part of a PCU shown in FIG. 1.

FIG. 3 is a diagram to describe a general layout of the inverter module of FIG. 2.

FIG. 4 represents a layout of an inverter module as a typical example of a semiconductor module according to a first embodiment of the present invention.

FIG. 5 represents a layout of an inverter module as a modification of a semiconductor module of the present invention.

FIG. 6 represents a layout of an inverter module as a modification of a semiconductor module of the present invention.

FIG. 7 represents a layout of an inverter module as a typical example of a semiconductor module according to a second embodiment of the present invention.

### BEST MODES FOR CARRYING OUT THE INVENTION

Embodiments of the present invention will be described hereinafter in detail with reference to the drawings. In the drawings, the same reference characters indicate the same or corresponding elements.

### First Embodiment

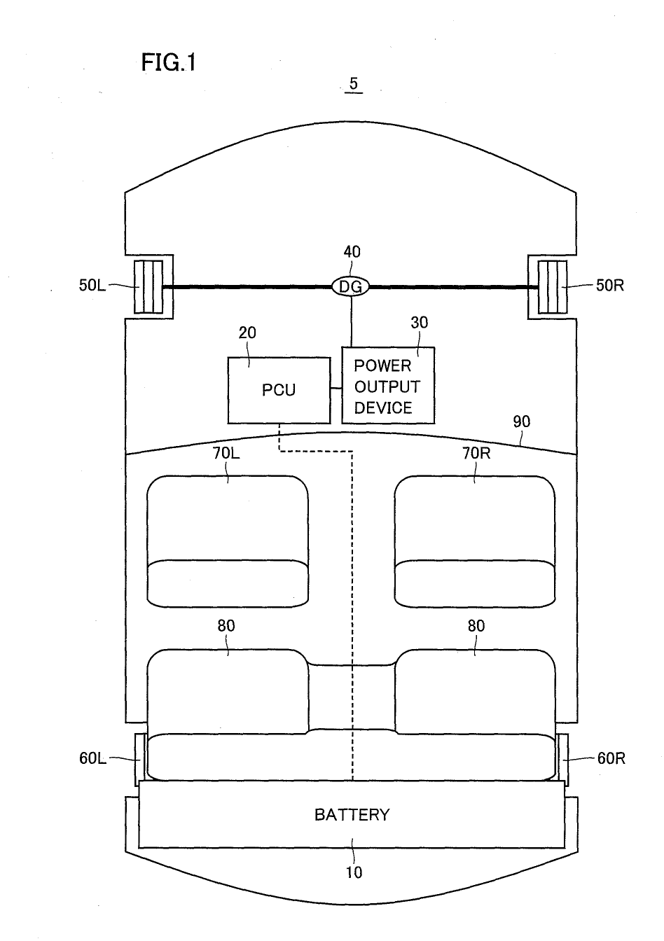

FIG. 1 is a schematic block diagram representing an entire configuration of a hybrid vehicle provided as an example of incorporating a power conversion apparatus of the present invention

Referring to FIG. 1a hybrid vehicle 5 includes a battery 10, a PCU (Power Control Unit) 20, a power output device 30, a differential gear (DG) 40, front wheels 50L, 50R, rear wheels 60L, 60R, front seats 70L, 70R, and a rear seat 80.

Battery 10 is arranged at the rearward side of rear seat 80. Battery 10 is electrically connected to PCU 20. PCU 20 is arranged utilizing the lower region of front seats 70L and 70R, i.e. the region under the floor. Power output device 30 is arranged at an engine room located forward of a dashboard 90. PCU 20 is electrically connected to power output device 30. Power output device 30 is coupled to DG 40.

Battery 10 that is a DC power supply is constituted of, for example, a secondary battery such as of nickel hydrogen or lithium ions. Battery 10 supplies DC voltage to PCU 20, and is charged by the DC voltage from PCU 20.

PCU 20 boosts the DC voltage from battery 10, and converts the boosted DC voltage into AC voltage for drive-controlling a motor generator included in power output device 30. PCU 20 also converts AC voltage generated by the motor generator in power output device 30 into DC voltage to charge battery 10. Namely, PCU 20 is equivalent to “power conversion apparatus” carrying out power conversion between the DC power supplied from battery 10 and the AC power for drive-controlling the motor or the AC power generated by a generator.

Power output device 30 transmits the motive power by the engine and/or motor generator to front wheels 50L and 50R via DG 40 to drive the same. Power output device 30 generates power by the rotation of front wheels 50L and 50R to provide the generated power to PCU 20. Alternatively, a motor generator having the functions of both a motor and a generator may be provided at power output device 30.

DG 40 transmits the motive power from power output device 30 to front wheels 50L and 50R, and transmits the rotation of front wheels 50L and 50R to power output device 30.

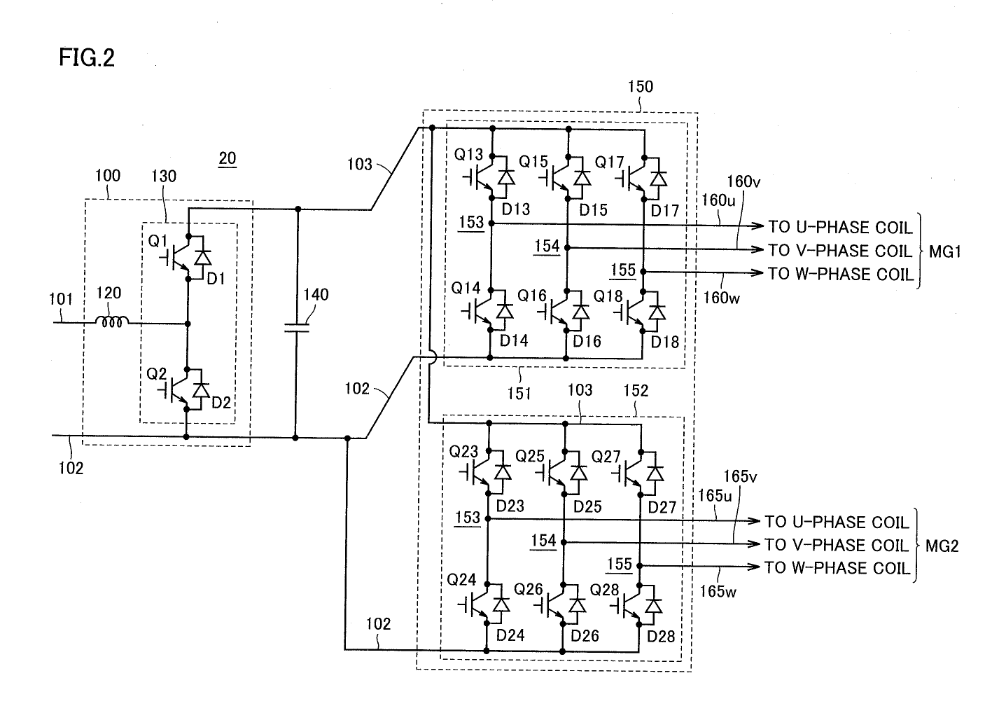

FIG. 2 is an electric circuit diagram representing a main part of PCU 20 shown in FIG. 1.

Referring to FIG. 2, PCU 20 includes a boost converter 100, a capacitor 140, and an inverter module 150.

Boost converter 100 constituting a non-insulating type boost chopper includes a reactor 120 and a boost power module 130. Boost power module 130 includes power switches Q1 and Q2, and diodes D1 and D2. In the present embodiment, IGBT is typically applied as a power switch.

Power switches Q1 and Q2 are connected in series between a power supply line 103 and an earth line 102. Power switch Q1 has its collector connected to power supply line 103, and its emitter connected to the collector of power switch Q2. Further, power switch Q2 has its emitter connected to earth line 102. Diodes D1 and D2 are provided as inverse-parallel diodes of each of power switches Q1 and Q2.

Reactor 120 has one end connected to power supply line 101 and the other end connected to a connection node of each of power switches Q1 and Q2. Capacitor 140 is connected between power supply line 103 and earth line 102.

Inverter module 150 is constituted of two inverters 151 and 152. Inverter 151 includes a U-phase arm 153, a V-phase arm 154 and a W-phase arm 155. U-phase arm 153, V-phase arm 154 and W-phase arm 155 are connected in parallel between power supply line 103 and earth line 102.

U-phase arm 153 is constituted of power switches Q13 and Q14 connected in series. V-phase arm 154 is constituted of power switches Q15 and Q16 connected in series. W-phase arm 155 is constituted of power switches Q17 and Q18 connected in series. Each of power switches Q13-Q18 is connected to inverse-parallel diodes D13-D18, respectively.

Output conductors 160u, 160v, and 160w corresponding to an intermediate point of each phase arm are connected to each phase end of each phase coil of motor generator MG1. Namely, motor generator MG1 is a 3-phase permanent magnet motor, having one ends of the three coils of the U, V and W phases connected in common to the intermediate point, and the other ends connected to output conductors 160u, 160v and 160w, respectively.

Inverter 152 has a configuration identical to that of inverter 151. Namely, in inverter 152, U-phase arm 153 is constituted of power switches Q23 and Q24 connected in series. V-phase arm 154 is constituted of power switches Q25 and Q26 connected in series. W-phase arm 155 is constituted of power switches Q27 and Q28 connected in series. Each of power switches Q23-Q28 is connected to inverse-parallel diodes D23-D28, respectively.

Output conductors 165u, 165v and 165w corresponding to the intermediate point of each phase arm in inverter 152 are connected to each phase end of each phase coil of motor generator MG2. Namely, motor generator MG2 is a 3-phase permanent magnet motor, having one ends of the three coils of the U, V and W phases connected in common to the intermediate point, and the other ends connected to output conductors 165u, 165v and 165w, respectively.

Boost converter 100 receives DC voltage supplied from battery 10 between power supply line 101 and earth line 102 to boost the DC voltage by switching-control of power switches Q1 and Q2. The boosted voltage is applied to capacitor 140.

Capacitor 140 smoothes the DC voltage from boost converter 100 and provides the smoothed voltage to inverters 151 and 152. Inverter 151 converts the DC voltage from capacitor 140 into AC voltage to drive motor generator MG1. Inverter 152 converts the DC voltage from capacitor 140 into AC voltage to drive motor generator MG2.

Inverter 151 converts the AC voltage generated by motor generator MG1 into DC voltage to be supplied to capacitor 140. Inverter 152 converts the AC voltage generated by motor generator MG2 into DC voltage to be supplied to capacitor 140.

Capacitor 140 smoothes the DC voltage from motor generator MG1 or MG2 and provides the smoothed voltage to boost converter 100. Boost converter 100 down-converts the DC voltage from capacitor 140 and supplies the voltage to battery 10 or a DC/DC converter not shown.

Boost power module 130 and inverter module 150 constituted of power switches and diodes are integrated to constitute a semiconductor module of the present invention. Reactor 120 and capacitor 140 for smoothing in boost converter 100 are arranged external to the semiconductor module since they are relatively large components.

[Configuration of Semiconductor Module of Present Invention]

For the purpose of describing an entire configuration of a semiconductor module according to the present invention, first an example of a general semiconductor module conventionally employed will be described for the sake of comparison.

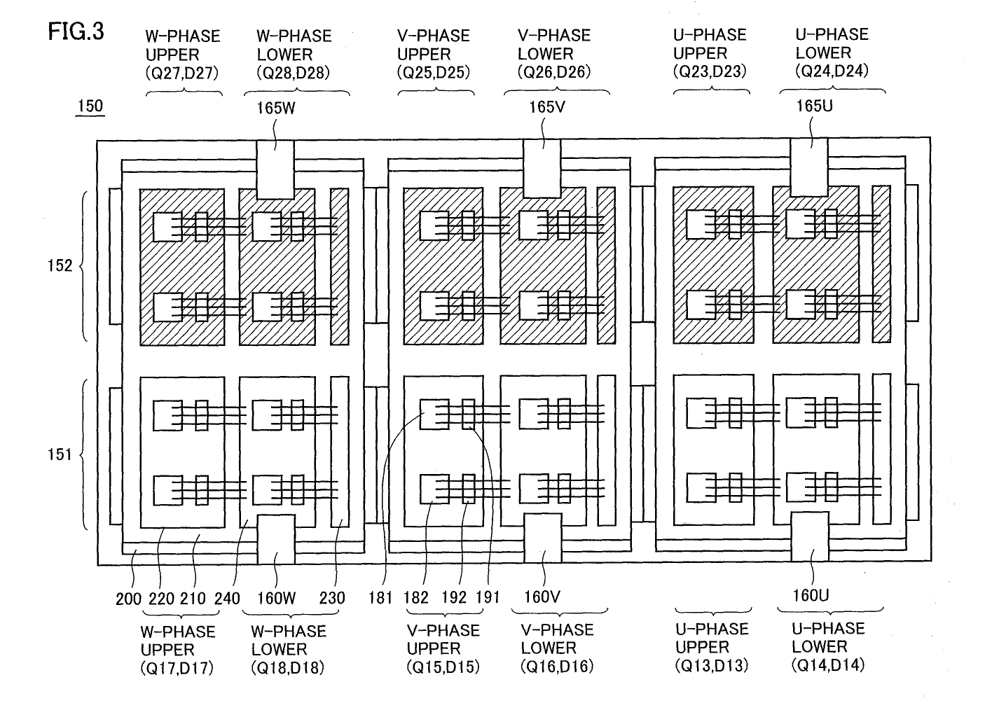

FIG. 3 is a diagram to describe a general layout of inverter module 150 of FIG. 2. For the sake of convenience, description will be provided with the up-down direction in FIG. 3 as the vertical direction and the lateral direction in FIG. 3 as the horizontal direction.

Referring to FIG. 3, power switches Q13-Q18 and Q23-Q28, as well as diodes D13-D18 and D23-D28, constituting inverters 151 and 152 in inverter module 150, are arranged regularly along the horizontal direction.

Each of the power switches Q13-Q18 and each of diodes D13-D18 in inverter 151 is formed of two semiconductor switching elements and two diode elements connected in parallel. In the following, the semiconductor switching elements and diode elements are also generically referred to as a semiconductor element. Further, since an IGBT is applied as a power switch, each semiconductor switching element is also referred to as an IGBT element.

For example, power switch Q15 of the V-phase upper arm is constituted of two IGBT elements 181 and 182 connected in parallel. Diode D15 is constituted of diode elements 191 and 192 connected in parallel.

Inverter 152 has a configuration identical to that of inverter 151. Specifically, each of power switches Q23-Q28 and each of diodes D23-D28 in inverter 152 is constituted of two IGBT elements and two diode elements connected in parallel.

These IGBT elements and diode elements are mounted on an insulation substrate 210. A radiator plate 200 is attached to the bottom of insulation substrate 210 with a lower aluminium electrode (not shown) therebetween. Radiator plate 200 transmits the heat from inverter module 150 to a cooler (not shown) to effect cooling of inverter module 150.

Metal electrodes 220, 230 and 240 are provided on insulation substrate 210. Metal electrode 220 is a P electrode corresponding to power supply line 103 in FIG. 2. Metal electrode 230 is an N electrode corresponding to earth line 102 in FIG. 2. Metal electrode 240 is an output electrode electrically connected to respective output conductors 160u-160v and 165u-165v shown in FIG. 2. Three of these P electrode 220, N electrode 230 and output electrode 240 are provided repeatedly corresponding to each of the U, V and W phases for each of inverters 151 and 152.

Each IGBT element and diode element are electrically connected to P electrode 220, N electrode 230 and output electrode 240 by wire bonding or the like to realize the electrical connection shown in FIG. 2.

For example, IGBT elements 181 and 182 constituting power switch Q15 in inverter 151 are connected in parallel by wire bonding between output electrode 240 connected to output conductor 160v and P electrode 220.

In the conventional module of FIG. 3, the area occupied by the entire inverter module is reduced by forming inverters 151 and 152 integrally on a common insulation substrate 210. Further, since such a module configuration allows a cooling mechanism to be shared between inverters 151 and 152, there is the advantage that the entire semiconductor module can be reduced in size.

It is to be noted that the drive current supplied to motor generators MG1 and MG2 take variable values changing independently according to each required output. There is a relative relationship in magnitude between the amount of heat generated from inverter 151 and the amount of heat generated from inverter 152. Since motor generator MG1 is mainly used for generating power and motor generator MG2 is mainly used for generating the driving force for the vehicle in the present embodiment, the amount of heat generated from inverter 152 tends to become greater than the amount of heat generated from inverter 151.

Reflecting this difference in the generated amount of heat, deviation will occur in the in-plane temperature distribution at insulation substrate 210, i.e. the region where inverter 152 is mounted becomes higher in temperature than the region where inverter 151 is mounted. There was thus a problem that the cooling performance for semiconductor elements located in the high-temperature region cannot be ensured, disallowing suppression of element temperature increase.

As means for suppressing temperature increase of semiconductor elements, there is known a method of controlling the cooling mechanism to have the cooling capability fixed to the level required corresponding to the highest heat generation. However, this method will needlessly increase power consumption of the cooling mechanism, causing degradation in the fuel cost for vehicles incorporating a semiconductor module.

Moreover, in the case where a large-scale cooling mechanism having a higher cooling capability is provided, the size of the power conversion apparatus will be increased, which will conflict with the demand for downsizing imposed on a power converter due to space constraints during mounting.

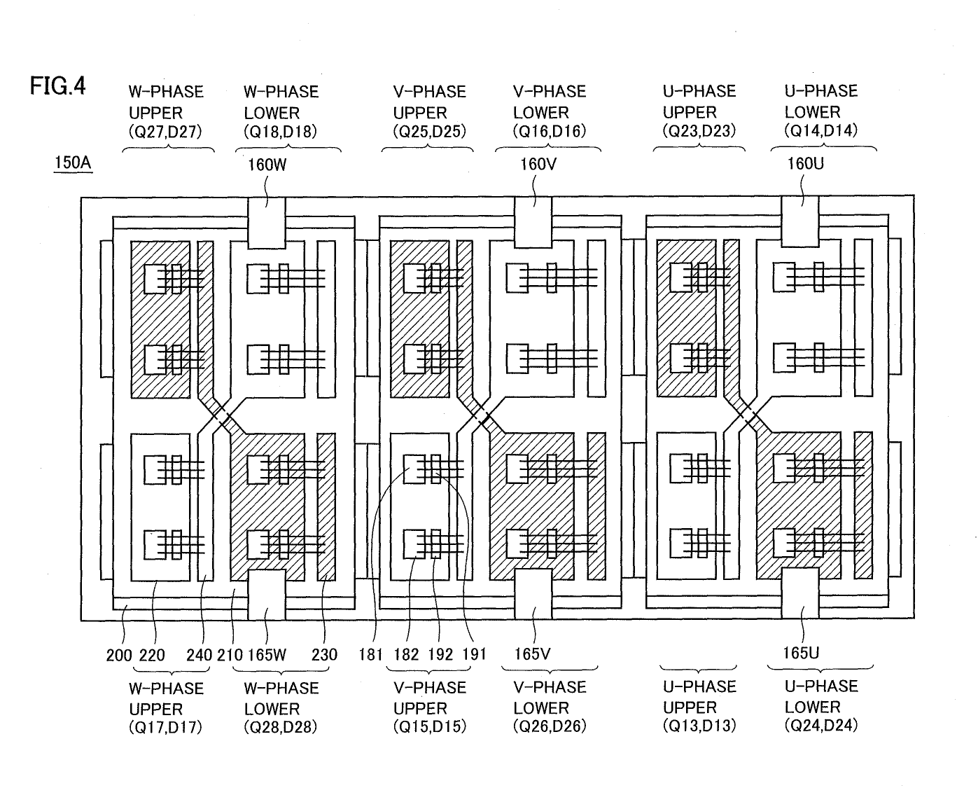

In view of the foregoing, the semiconductor module according to a first embodiment of the present invention is characterized in that the arm of each phase in inverter 151 and the arm of each phase in inverter 152 are arranged in a displaced manner, and to be adjacent to the arm of a different inverter along the horizontal direction. Such an arrangement can be realized by shifting the arms adjacent in the horizontal direction (upper arm and lower arm) so as to be displaced from each other in the vertical direction in inverters 151 and 152, as shown in, for example, FIG. 4.

FIG. 4 represents a layout of an inverter module 150A typical of a semiconductor module according to the first embodiment of the present invention.

Referring to FIG. 4, in inverter module 150A, power switches Q13-Q18 and diodes D13-D18 constituting inverter 151 are arranged on insulation substrate 210 in a displaced manner. Specifically, power switches and diodes constituting different arms of the same phase are arranged displaced from each other in the vertical direction.

Power switches Q23-Q28 and diodes D23-D28 constituting inverter 152 are also arranged in a displaced manner on insulation substrate 210. Here, each power switch and each diode in inverter 152 are arranged to be adjacent in the horizontal direction to each power switch and each diode in inverter 151.

Upon comparing inverter module 150A of FIG. 4 with inverter module 150 shown in FIG. 3, it will be appreciated that power switches Q23-Q28 in inverter 152 arranged in one row in the horizontal direction in FIG. 3 are arranged such that adjacent power switches are alternately displaced in the same vertical direction. Accordingly, power switches Q23-Q28 and diodes D23-D28 of inverter 152 having a relatively high generated amount of heat can be arranged evenly in the in-plane direction of insulation substrate 210.

Moreover, power switches Q13-Q18 and diodes D13-D18 of inverter 151 that has a relatively low generated amount of power are arranged between power switches Q23-Q28 and diodes D23-D28 of inverter 152 that are adjacent to each other in the horizontal direction. Thus, power switches Q13-Q18 and diodes D13-D18 can be arranged uniformly in the in-plane direction of insulation substrate 210.

Namely, inverter module 150A of the present embodiment realizes uniformity in the in-plane temperature distribution of the substrate while ensuring a substrate occupying area substantially equal to that of inverter module 150.

Accordingly, the deviation occurring in a conventional inverter module 150 (FIG. 3) when switching-control of inverters 151, 152 is carried out can be reduced. Since the cooling performance can be ensured for the semiconductor elements of inverter 152 that attains a relatively high temperature, increase of the element temperature can be suppressed. As a result, power of the cooling mechanism can be saved since it is not necessary to increase the cooling performance of the cooling mechanism in order to ensure the cooling performance of the semiconductor element. Thus, the fuel cost of the vehicle in which inverter module 150A is incorporated can be improved. Further, increase in the size of the cooling mechanism can be prevented.

Inverter 151 corresponds to “first power converter”. Semiconductor switching elements and diode elements constituting inverter 151 correspond to “first semiconductor element”. Power switches Q13-Q18 and diodes D13-D18 constituting the arm of each phase in inverter 151 correspond to “first semiconductor element group”, each first semiconductor element group including at least one semiconductor element.

Further, inverter 152 corresponds to “second power converter”. Semiconductor switching elements and diode elements constituting inverter 152 correspond to “second semiconductor element”. Power switches Q23-Q28 and diodes D23-D28 constituting the arm of each phase in inverter 152 correspond to “second semiconductor element group”, each second semiconductor element group including at least one second semiconductor element.

[Modification]

The first embodiment set forth above is directed to rendering the temperature distribution uniform in the in-plane direction of insulation substrate 210 by organizing the power switches and diodes constituting the arm of each phase in inverters 151 and 152 into semiconductor element groups, each semiconductor element group including at least one semiconductor element, and arranged in a displaced manner on an insulation substrate.

The advantage of the present invention can also be provided according to the present modification in which each phase of inverters 151 and 152 is taken as a semiconductor element group, and each phase is arranged in a displaced manner.

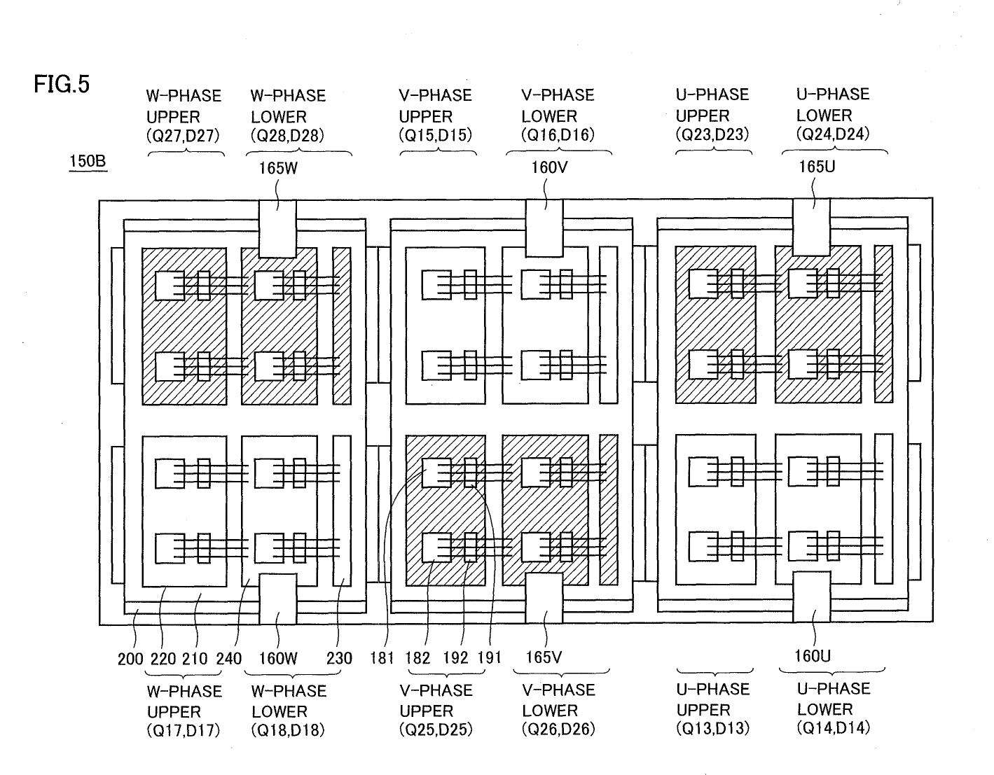

FIG. 5 represents a layout of an inverter module 150B identified as a modification of a semiconductor module of the present invention.

Referring to FIG. 5, in inverter module 150B, a U-phase arm 153 (power switches Q13, Q14, and diodes D13, D14), a V-phase arm 154 (power switches Q15, Q16 and diodes D15, D16), and a W-phase arm 155 (power switches Q17, Q18 and diodes D17, D18) constituting inverter 151 are arranged in a displaced manner on insulation substrate 210. Specifically, phases adjacent in the horizontal direction are located displaced from each other in the vertical direction.

Further, U-phase arm 153 (power switches Q23, Q24, and diodes D23, D24), V-phase arm 154 (power switches Q25, Q26, and diodes D25, D26) and W-phase arm 155 (power switches Q27, Q28 and diodes D27, D28) constituting inverter 152 are arranged in a displaced manner on insulation substrate 210. Respective phases in inverter 152 are arranged so as to be adjacent to respective phases in inverter 151 along the horizontal direction.

Comparing inverter module 150B shown in FIG. 5 with inverter module 150 shown in FIG. 3, it is appreciated that 3-phase arms 153-155 of inverter 152 arranged in one row in the horizontal direction are arranged such that adjacent phases are displaced alternately in the vertical direction. Accordingly, power switches Q23-Q28 and diodes D23-D28 in inverter 152 exhibiting a relatively large generated amount of heat can be arranged evenly in the in-plane direction of insulation substrate 210.

Moreover, arms 153-155 of three phases in inverter 151 exhibiting a relatively low generated amount of heat are arranged between arms 153-155 of the three phases in inverter 152 adjacent in the horizontal direction. Accordingly, power switches Q13-Q18 and diodes D13-D18 are arranged evenly in the in-plane direction of insulation substrate 210. Further, the area occupied by inverter module 150B at insulation substrate 210 is maintained substantially equal to the area occupied by inverter module 150 (FIG. 3) at insulation substrate 210.

By the arrangement of inverter module 150B as shown in FIG. 5, the in-plane temperature distribution of insulation substrate 210 can be rendered uniform when switching-control of inverters 151 and 152 is carried out. Therefore, the cooling performance of the semiconductor elements in inverter 152 exhibiting a relatively high temperature is ensured to allow temperature increase to be suppressed. As a result, power of the cooling mechanism can be saved, since it is not necessary to improve the cooling performance of the cooling mechanism in order to ensure the cooling performance of the semiconductor element. The fuel cost of the vehicle in which inverter module 150B is incorporated can be improved. Further, increase in the size of the cooling mechanism can be prevented.

In the present modification, each of three-phase arms 153-155 in inverter 151 corresponds to “first semiconductor element group” including at least one semiconductor element. Further, each of three-phase arms 153-155 in inverter 152 corresponds to “second semiconductor element group” including at least one second semiconductor element.

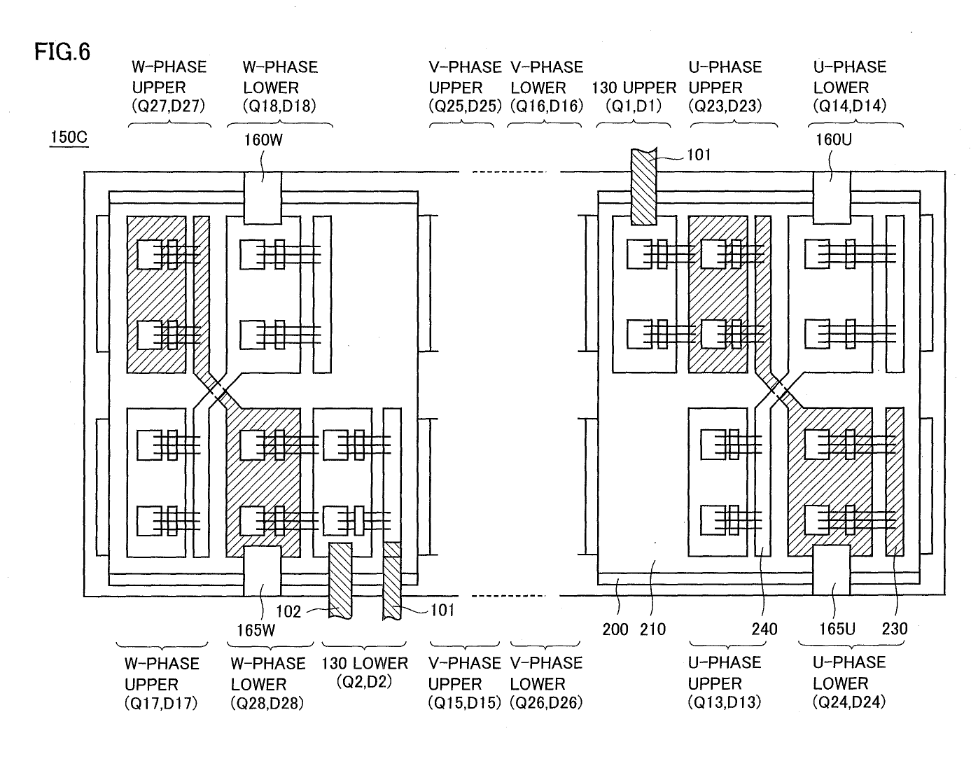

For boost power module 130 (FIG. 2) constituting a semiconductor module together with inverter module 150A (or 150B), the upper arm (power switch Q1 and diode D1) of boost converter 100 and the lower arm (power switch Q2 and diode D2) of boost converter 100 are arranged displaced from each other in the vertical direction in FIG. 6, and so as to be adjacent to the arm of inverter 151 or 152 in the horizontal direction. By such an arrangement, the temperature distribution in the in-plane direction of insulation substrate 210 can be rendered uniform.

Specifically, referring to FIG. 6, power switch Q1 and diode D1 are arranged at the U-phase side of inverter module 150C, whereas power switch Q2 and diode D2 are arranged at the W-phase side of inverter module 150C.

### Second Embodiment

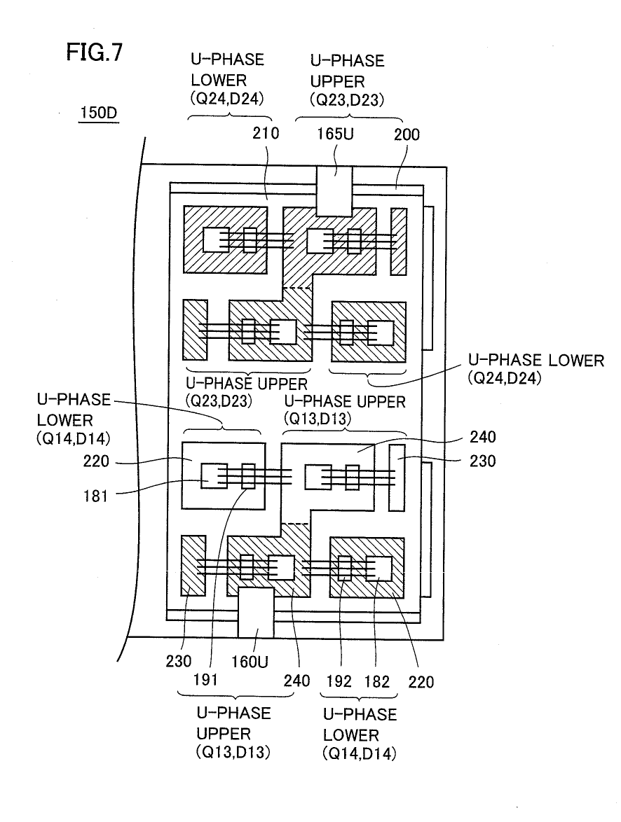

FIG. 7 represents a layout of an inverter module 150D that is a typical example of a semiconductor module according to a second embodiment of the present invention. For the sake of simplification in FIG. 7, only the U-phase arm of inverter module 150 shown in FIG. 3 is extracted and depicted. The illustration and description of the V-phase arm and W-phase arm having a similar configuration will not be repeated.

Referring to FIG. 7, in inverter module 150D, two semiconductor elements (IGBT element and diode element) constituting the same arm of the same phase are arranged in a displaced manner on insulation substrate 210.

Specifically, power switch Q13 of the U-phase upper arm in inverter 151 is constituted of IGBT elements 181 and 182 connected in parallel. In the present configuration, adjacent IGBT element 181 and IGBT element 182 are arranged so as to be displaced in the horizontal direction in FIG. 7. In accordance with such an arrangement of the two IGBT elements, P electrode 220, N electrode 230 and output electrode 240 shown in FIG. 3 are respectively divided into two, and arranged to be displaced in the horizontal direction.

Similarly, two IGBT elements constituting power switch Q14 of the U-phase lower arm in inverter 151 are arranged to be displaced from each other in the horizontal direction in FIG. 7. One of the IGBT elements constituting power switch Q13 and one of the IGBT elements constituting power switch Q14 are arranged to be adjacent in the vertical direction in FIG. 7.

Furthermore, two diode elements 191 and 192 constituting each of diode D13 of the U-phase upper arm and diode D14 of the U-phase lower arm are arranged in a displaced manner, integrally with IGBT elements 181 and 182, respectively.

Such an arrangement is similarly applied with respect to power switch Q23 and diode D23 of the U-phase upper arm and power switch Q24 and diode D24 of the U-phase lower arm in inverter 152.

According to the present embodiment, the in-plane temperature distribution at insulation substrate 210 can be rendered uniform without having to increase the area occupied by insulation substrate 210 by arranging the plurality of semiconductor elements constituting the same arm of the same phase in a displaced manner, and each to be adjacent to a semiconductor element constituting a different arm of the same phase.

Accordingly, heat interference between semiconductor elements is alleviated since the distance between elements that are energized simultaneously to generate heat becomes longer when switching-control is carried out at inverters 151 and 152. Since the in-plane temperature distribution at insulation substrate 210 is rendered uniform, the cooling performance of the semiconductor element can be ensured to suppress increase of the element temperature. As a result, power of the cooling mechanism can be saved since it is not necessary to increase the cooling performance of the cooling mechanism. Thus, the fuel cost of the vehicle in which inverter module 150D is incorporated can be improved. Further, increase in the size of the cooling mechanism can be prevented.

The arrangement according to the present embodiment can be applied, not only to inverter module 150 of FIG. 3, but also to inverter module 150B of FIG. 5. Particularly in the case where the present arrangement is applied to inverter module 150B, increase of the element temperature can be suppressed more effectively since the in-plane temperature distribution at insulation substrate 210 can be rendered more uniform.

Further, the arrangement of the present embodiment can also be applied to boost power module 130. In this case, a plurality of semiconductor elements constituting the same arm in boost converter 100 are arranged in a displaced manner, and each semiconductor element is arranged adjacent to a semiconductor element constituting a different arm.

In the first and second embodiments of the present invention set forth above, a semiconductor module of the present invention employed in a power supply device (PCU) in a hybrid vehicle was provided as a typical example corresponding to an application in which the demand for a smaller semiconductor module is great due to space constraints in mounting. However, application of the present invention is not limited to such a configuration, and may be applied common to a semiconductor module having a configuration in which at least one power converter is formed integrally on the same element substrate.

The present description is based on, but not limited to the case where an IGBT element is employed as a semiconductor switching element. A MOS transistor or the like may also be used in the configuration. In the case where a MOS transistor is employed as a semiconductor switching element, the diode element is omitted from the semiconductor element since a diode formed parasitically in the MOS transistor will function as an inverse-parallel diode.

It should be understood that the embodiments disclosed herein are illustrative and non-restrictive in every respect. The scope of the present invention is defined by the appended claims, rather than the description set forth above, and all changes that fall within limits and bounds of the claims, or equivalent thereof are intended to be embraced by the claims.

### INDUSTRIAL APPLICABILITY

The present invention can be applied to a power conversion apparatus including a plurality of power converters.

1. A power conversion apparatus comprising:
a first power converter driving a first electric load by switching-control of a plurality of first semiconductor elements, and
a second power converter driving a second electric load by switching-control of a plurality of second semiconductor elements,
said plurality of first semiconductor elements being organized into a plurality of first semiconductor element groups, each first semiconductor element group including at least one first semiconductor element,
said plurality of second semiconductor elements being organized into a plurality of second semiconductor element groups, each second semiconductor element group including at least one second semiconductor element,
said first power converter being a first inverter carrying out power conversion between a power supply and said first electric load, each of said plurality of first semiconductor element groups constituting an arm of each phase in said first inverter,
said second power converter being a second inverter carrying out power conversion between said power supply and said second electric load, each of said plurality of second semiconductor element groups constituting an arm of each phase in said second inverter,
said plurality of first semiconductor element groups being arranged in alignment in a first direction on a substrate, and at least some of the first semiconductor element groups adjacent in said first direction being arranged displaced from each other in a second direction perpendicular to said first direction, and
said plurality of second semiconductor element groups being arranged in alignment in said first direction on said substrate, and at least some of the second semiconductor element groups adjacent in said first direction being arranged displaced from each other in said second direction and to be adjacent to said first semiconductor element group along said first direction.

2. (canceled)

3. (canceled)

4. The power conversion apparatus according to claim 1, further comprising a third power converter carrying out voltage conversion between said power supply and said first and second power converters by switching-control of a plurality of third semiconductor elements, wherein
said plurality of third semiconductor elements are organized into a plurality of third semiconductor element groups, each third semiconductor element group including at least one third semiconductor element, and
each of said plurality of third semiconductor element groups is arranged in alignment in said first direction on said substrate, and at least some of the third semiconductor element groups adjacent in said first direction are arranged displaced from each other in said second direction and to be adjacent to said first or second semiconductor element group along said first direction.

5. The power conversion apparatus according to claim 1, further comprising a cooling mechanism provided to allow heat exchange with said substrate.

6. A power conversion apparatus converting power received between a first power supply line and a second power supply line from a power supply, said power conversion apparatus comprising:
a plurality of first semiconductor elements connected in parallel between said first power supply line and an output conductor, and
a plurality of second semiconductor elements connected in parallel between said second power supply line and said output conductor,
said plurality of first semiconductor elements being arranged in alignment in a first direction on a substrate, and at least some of the first semiconductor elements adjacent in said first direction being arranged displaced from each other in a second direction perpendicular to said first direction, and
said plurality of second semiconductor elements being arranged in alignment in said first direction, and at least some of the second semiconductor elements adjacent in said first direction being arranged displaced from each other in said second direction and to be adjacent to said first semiconductor element along said first direction.

7. The power conversion apparatus according to claim 6, wherein said power conversion apparatus is an inverter carrying out power conversion between DC power received between said first power supply line and said second power supply line and AC power transmitted to and received from an electric load.

8. The power conversion apparatus according to claim 6, wherein said power conversion apparatus is a converter carrying out voltage conversion of DC power received between said first power supply line and said second power supply line.

9. The power conversion apparatus according to claim 6, further comprising a cooling mechanism provided to allow heat exchange with said substrate.
